(19) United States
(12) Patent Application Publication
(10) Pub. No.: US 2015/0013157 A1
(43) Pub. Date: Jan. 15, 2015

(54) STRUCTURE AND METHOD FOR ASSEMBLING CONNECTOR

(71) Applicant: YAZAKI CORPORATION, Tokyo (JP)

(72) Inventors: Yoji KUTSUNA, Makinohara-shi (JP); Shin NEMOTO, Makinohara-shi (JP)

(21) Appl. No.: 14/501,558

(22) Filed: Sep. 30, 2014

Related U.S. Application Data
(63) Continuation of application No. PCT/JP2013/002031, filed on Mar. 26, 2013.

(30) Foreign Application Priority Data
Apr. 5, 2012 (JP) 2012-086498

(51) Int. Cl. H01R 43/20

(52) U.S. Cl. CPC H01R 43/20
USPC 29/876; 29/747

(57) ABSTRACT

A connector assembling structure includes: a connector including a connector housing provided with terminal chambers, lance entry holes opening into the terminal chambers, and a retainer insertion hole opening into the terminal chambers, terminals inserted and housed in the terminal chambers, and a retainer inserted in the retainer insertion hole to lock the terminals housed in the terminal chambers and thereby to prevent the terminals from moving in the direction opposite to the insertion direction of the terminals; and a jig detachably provided on the connector housing, and including flexible locking lances which enter the terminal chambers via the lance entry holes in the state in which the jig is attached to the connector housing.

### CROSS REFERENCE TO RELATED APPLICATIONS

This application is a Continuation of PCT Application No. PCT/JP2013/002031, filed on Mar. 26, 2013, and claims the priority of Japanese Patent Application No. 2012-086498, filed on Apr. 5, 2012, the content of both of which is incorporated herein by reference.

### BACKGROUND

1. Technical Field

The present invention relates to a structure and method for assembling a connector as a part of a wire harness mounted on a vehicle or the like.

2. Related Art

Various types of connectors composing wire harnesses mounted on a vehicle have been proposed (see JP H08-050953 A). As illustrated in FIGS. 1 and 2, a connector 100 according to a conventional example includes a connector housing 104 and a terminal locking spacer 106, each made of synthetic resin. The connector housing 104 includes terminal chambers 102 each to be housing one of a plurality of terminals 101, and a spacer insertion room 103 perpendicular to the respective terminal chambers 102. The terminal locking spacer 106 includes a plurality of terminal insertion holes 105 corresponding to the respective terminal chambers 102, and is inserted into the spacer insertion room 103.

Each of the terminal chambers 102 is provided with a flexible locking lance 107 integrated with and projecting from a bottom wall thereof The flexible locking lance 107 engages with each of the terminals 101 so that each of the terminals 101 is prevented from being pulled out from a rear side of each of the terminal chambers 102. Each of the terminal chambers 102 is also provided with a stopper wall 109 at a front opening to prevent each of the terminals 101 from passing through the front opening.

As illustrated in FIG. 1, when the terminal locking spacer 106 of the connector 100 is in a temporary locking state, each of the terminals 101 passes through the terminal insertion hole 105 of the terminal locking spacer 106, and comes into contact with and stops at the stopper wall 109. At the same time, each of the terminals 101 engages with the flexible locking lance 107, and is thus preliminarily locked. Subsequently, as illustrated in FIG. 2, the terminal locking spacer 106 is pushed downward so as to be shifted from the temporary locking state to a locking state. As a result, a back stepped portion 110 of each of the terminals 101 engages with the terminal locking spacer 106 so that each of the terminals 101 is prevented from being pulled out from the rear side of each of the terminal chambers 102 (secondary locking).

In the connector 100 (a so-called double-locking connector), since backward removal of each of the terminals 101 is doubly prevented by the flexible locking lance 107 and the terminal locking spacer 106, the connector 100 is generally used as follows. In order to simply hold each of the terminals 101 housed in each of the terminal chambers 102 at the time of manufacturing a wire harness, the preliminary locking is carried out by the flexible locking lance 107 in each of the terminal chambers 102. Then, in order to hold each of the terminals 101 in a manner as to be, resistant to a wire tensile force at the time of mounting the connector on a vehicle, the secondary locking is carried out by the terminal locking spacer 106, and each of the terminals 101 is supplementarily locked with the flexible locking lance 107 in each of the terminal chambers 102.

### SUMMARY

However, in the connector 100 according to the conventional example, since the flexible locking lance 107 are provided in each of the terminal chambers 102, the weight of the connector housing 104 increases. Further, a motion space for the flexible locking lance 107 is provided in each of the terminal chambers 102, which increases the size of the connector housing 104.

The present invention has been made in view of the above-described problem. It is an object of the present invention to provide a structure and method for assembling a connector capable of reducing the size and weight of the connector.

A connector assembling structure according to a first aspect of the present invention includes: a connector including a connector housing provided with a terminal chamber, a lance entry hole opening into the terminal chamber, and a retainer insertion hole opening into the terminal chamber, a terminal inserted and housed in the terminal chamber, and a retainer inserted in the retainer insertion hole to lock the terminal housed in the terminal chamber and thereby to prevent the terminal from moving in a direction opposite to an insertion direction of the terminal; and a jig detachably provided on the connector housing, and including a flexible locking lance which enters the terminal chamber via the lance entry hole in a state in which the jig is attached to the connector housing.

The connector assembling structure may include two or more sets of the terminal chamber, the lance entry hole, the terminal, and the flexible locking lance.

The jig may be composed of a pair of upper and lower portions.

A connector assembling method according to a second aspect of the present invention includes: attaching a jig to a connector housing; inserting a flexible locking lance of the jig into a terminal chamber of the connector housing via a lance entry hole of the connector housing; inserting and housing a terminal in the terminal chamber; locking the terminal housed in the terminal chamber with the flexible locking lance to prevent the terminal from moving in a direction opposite to an insertion direction of the terminal; inserting a retainer into a retainer insertion hole of the connector housing; locking the terminal with the retainer to prevent the terminal from moving in the direction opposite to the insertion direction of the terminal; and removing the jig from the connector housing.

According to the aspects of the present invention, in the state where the jig including the flexible locking lances is attached to the connector housing, the terminals and the retainer are attached to the connector housing in a manner such that the terminals are locked with the retainer. Thereafter, the jig is removed from the connector housing. Due to such a configuration, it is possible to lock the terminals during the process and after the process of attaching the terminals to the connector housing without providing the flexible locking lances in the connector housing. Therefore, it is possible to eliminate the flexible locking lances themselves and motion spaces for the flexible locking lances from the connector housing. Accordingly, the size and weight of the connector can be reduced.

### BRIEF DESCRIPTION OF DRAWINGS

FIG. 1 is a cross sectional view illustrating a connector in a temporary locked state according to a conventional example.

FIG. 2 is a cross sectional view illustrating the connector in a locked state according to the conventional example.

FIG. 3 is an exploded perspective view of a connector assembling structure according to an embodiment.

FIG. 4 is a perspective view of a connector housing according to the embodiment.

FIG. 5 is a plan view of the connector housing.

FIG. 6 is a front view of the connector housing.

FIG. 7 is a bottom view of the connector housing.

FIG. 8 is a side view of the connector housing.

FIG. 9 is a perspective view of the connector housing to which a lower jig portion is attached.

FIG. 10 is a perspective view of the connector housing to which a jig is attached.

FIG. 11 is a lower perspective view of the connector housing to which the jig is attached.

FIG. 12 is a bottom view of the connector housing to which the jig is attached.

FIG. 13 is a plan view of the connector housing to which the jig is attached.

FIG. 14 is a back view of the jig and connector housing.

FIG. 15 is a cross sectional view along the line A-A in FIG. 14.

FIG. 16 is a side view of the connector housing to which the jig is attached.

FIG. 17 is a perspective view illustrating the state before a terminal is inserted into a terminal chamber of a lower row of the connector housing.

FIG. 18 is a perspective view illustrating the state after the terminal is inserted into the terminal chamber of the lower row of the connector housing.

FIG. 19 is a perspective view illustrating a state before a retainer is inserted into the connector housing.

FIG. 20 is a perspective view illustrating a state after the retainer is inserted into the connector housing.

FIG. 21 is a back view illustrating the state after the retainer is inserted into the connector housing.

FIG. 22 is a cross sectional view illustrating the state in which the terminal is inserted into the terminal chamber of the lower row of the connector housing.

FIG. 23 is a cross sectional view illustrating a state in which terminals are inserted into the terminal chambers of upper and lower rows of the connector housing.

FIG. 24 is a cross sectional view along the line B-B in FIG. 21.

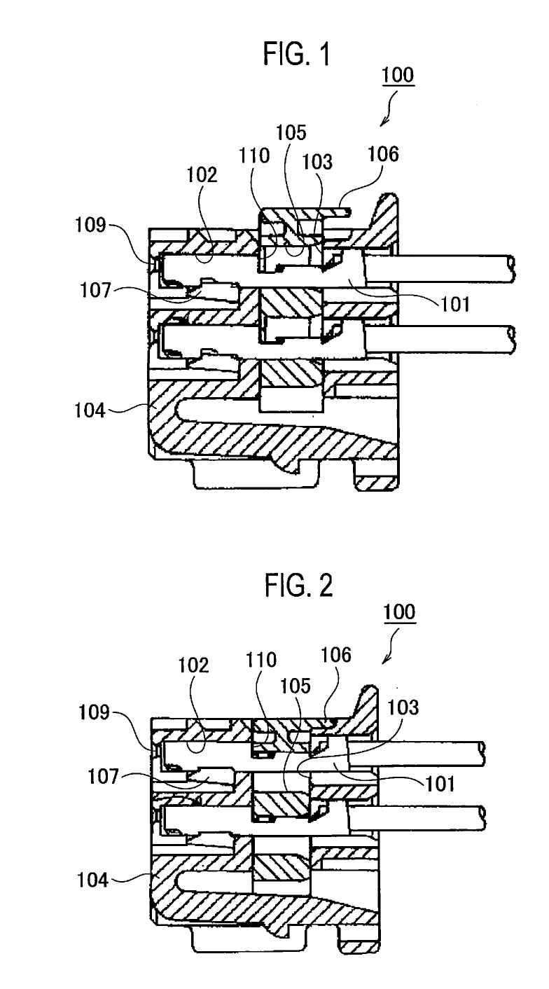

### DETAILED DESCRIPTION

Hereinafter, an embodiment of the present invention will be explained with reference to the drawings.

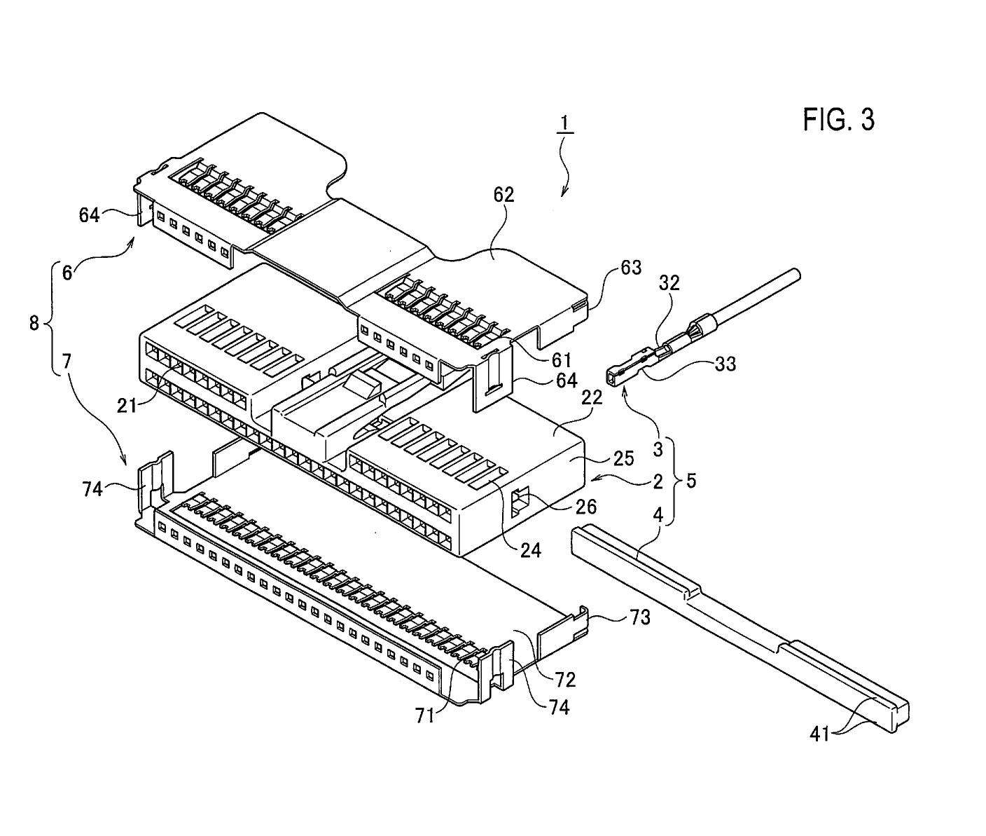

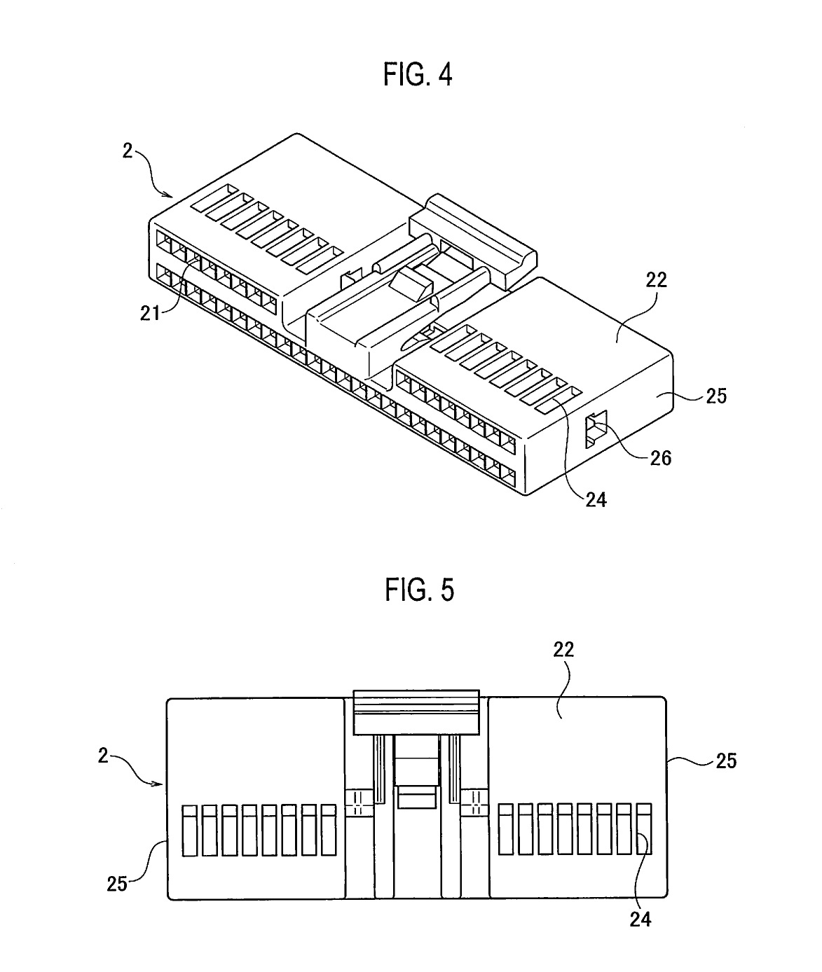

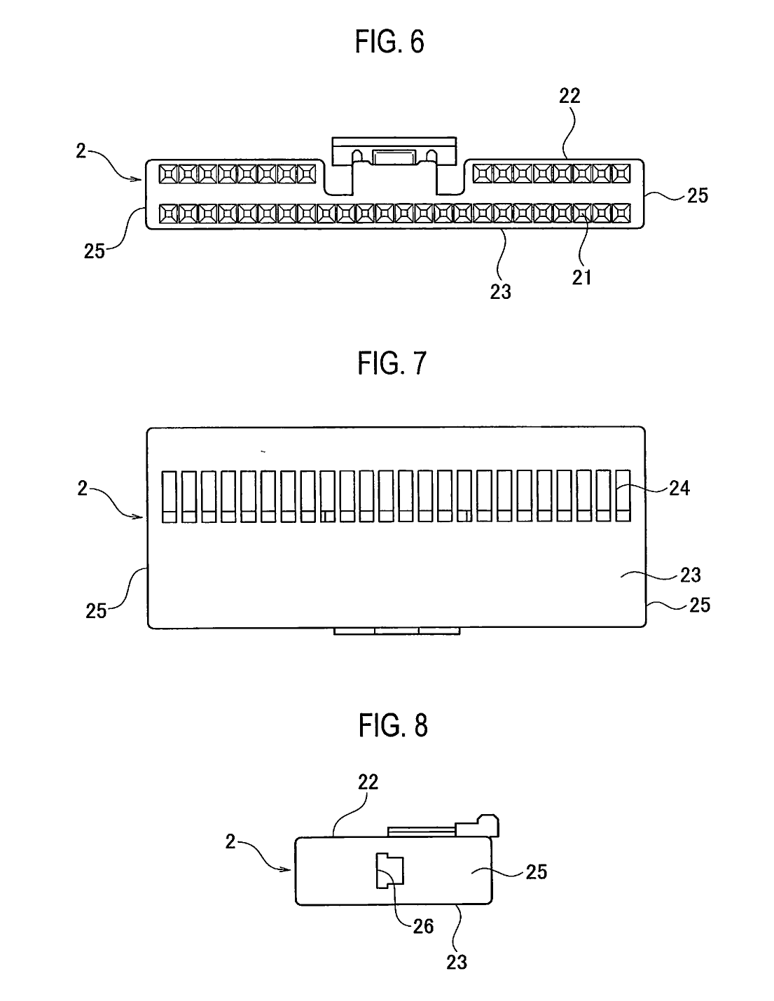

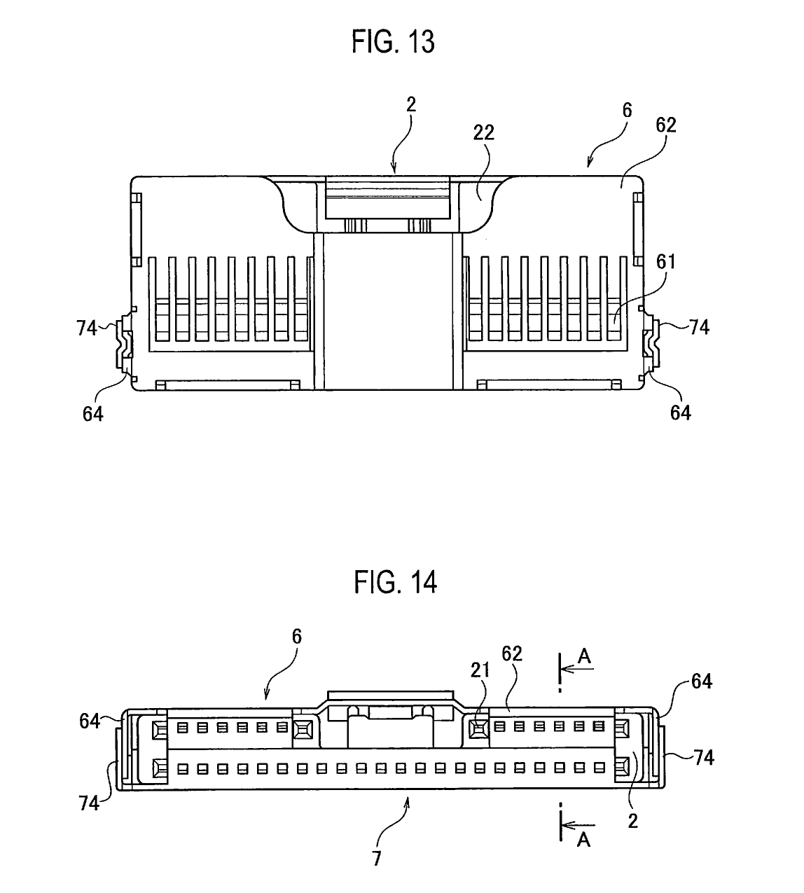

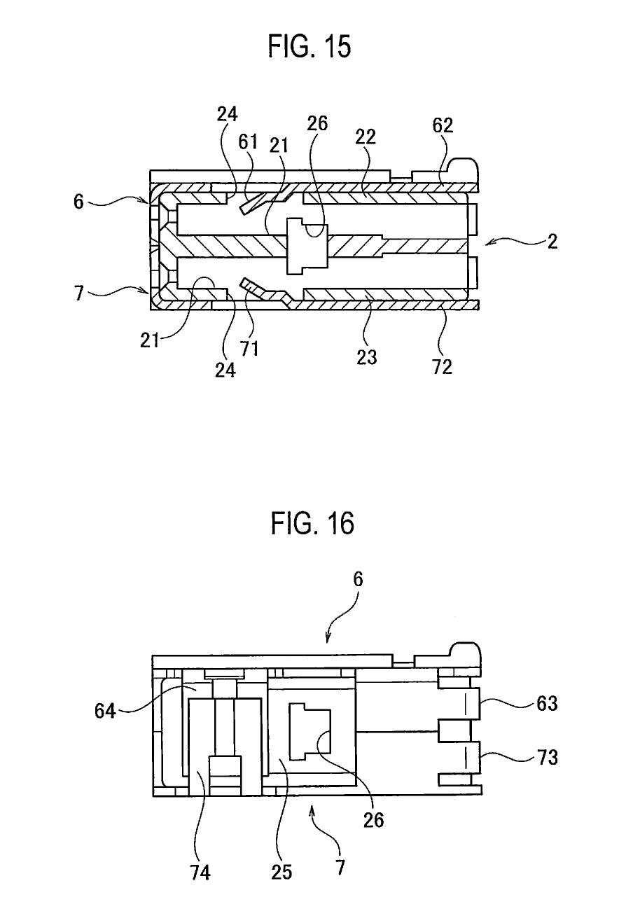

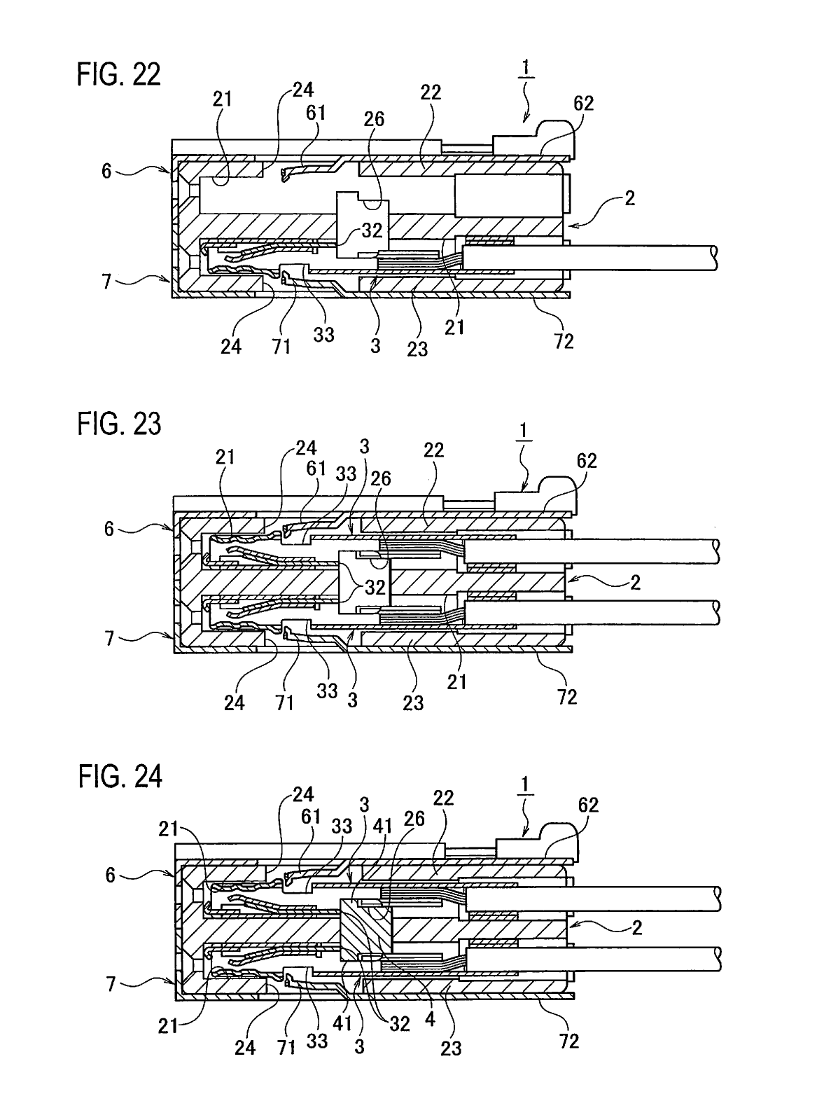

As illustrated in FIGS. 3 to 24, a connector assembling structure 1 according to the embodiment includes; a connector 5 including a connector housing 2, terminals (female terminals) 3, and a retainer 4; and a jig 8 including an upper jig portion 6 and a lower jig portion 7 to be attached to the connector housing 2.

The connector housing 2 is formed into substantially a box shape made of synthetic resin. A plurality of terminal chambers 21 are provided in upper and lower rows in the connector housing 2. Each of the terminals 3 is inserted and housed in each of the terminal chambers 21. The connector housing 2 is provided, on a top plate 22 and a bottom plate 23, with lance entry holes 24 opening into the corresponding terminal chambers 21. The connector housing 2 is also provided, on a side plate 25, with an opening of a retainer insertion hole 26 opening into all of the terminal chambers 21 arranged in the upper and lower rows. Namely, the retainer insertion hole 26 passes through all of the terminal chambers 21.

The retainer 4 is formed into an elongated shape having the same cross sectional shape as the retainer insertion hole 26, and is provided with projections 41 projecting upward and downward and elongated in the longitudinal direction of the retainer 4. The retainer 4 is inserted in the connector housing 2 in the direction perpendicular to the terminal chambers 21 through the retainer insertion hole 26. A recess portion 32 of each of the terminals 3 housed in each of the terminal chambers 21 is thus locked with the projections 41 of the retainer 4 so that the terminals 3 are prevented from moving in the direction opposite to the insertion direction of the terminals 3. That is, the terminals 3 are prevented from being pulled out from the rear side of the respective terminal chambers 21.

The jig 8 is detachably provided on the connector housing 2. In a state where the jig 8 is attached to the connector housing 2, a plurality of upper flexible locking lances 61 of the upper jig portion 6 enter the terminal chambers 21 of the upper row via the respective lance entry holes 24 provided on the top plate 22 of the connector housing 2. Similarly, a plurality of lower flexible locking lances 71 of the lower jig portion 7 enter the terminal chambers 21 of the lower row via the respective lance entry holes 24 provided on the bottom plate 23 of the connector housing 2. The upper flexible locking lances 61 are integrated with a top plate 62 of the upper jig portion 6 and project therefrom. Once a locking groove 33 of each of the terminals 3 housed in each of the terminal chambers 21 of the upper row is locked with each of the upper flexible locking lances 61, each of the terminals 3 is prevented from moving in the direction opposite to the insertion direction of each of the terminals 3, namely, the terminals 3 of the upper row are prevented from being pulled out from the rear side of the terminal chambers 21 of the upper row. Similarly, the lower flexible locking lances 71 are integrated with a bottom plate 72 of the lower jig portion 7. Once the locking groove 33 of each of the terminals 3 housed in each of the terminal chambers 21 of the lower row is locked with each of the lower flexible locking lances 71, each of the terminals 3 is prevented from moving in the direction opposite to the insertion direction of each of the terminals 3, namely, the terminals 3 of the lower row are prevented from being pulled out from the rear side of the terminal chambers 21 of the lower row.

The upper jig portion 6 includes upper positioning portions 63 and upper locking portions 64 on both sides. The upper positioning portions 63 are provided for the positioning of the upper jig portion 6 attached to the upper portion of the connector housing 2. The lower jig portion 7 includes lower positioning portions 73 and lower locking portions 74. The lower positioning portions 73 are provided for the positioning of the lower jig portion 7 attached to the lower portion of the connector housing 2. The upper locking portions 64 and the lower locking portions 74 keep the jig 8 attached to the connector housing 2.

Next, a procedure of assembling the connector 5 is explained below.

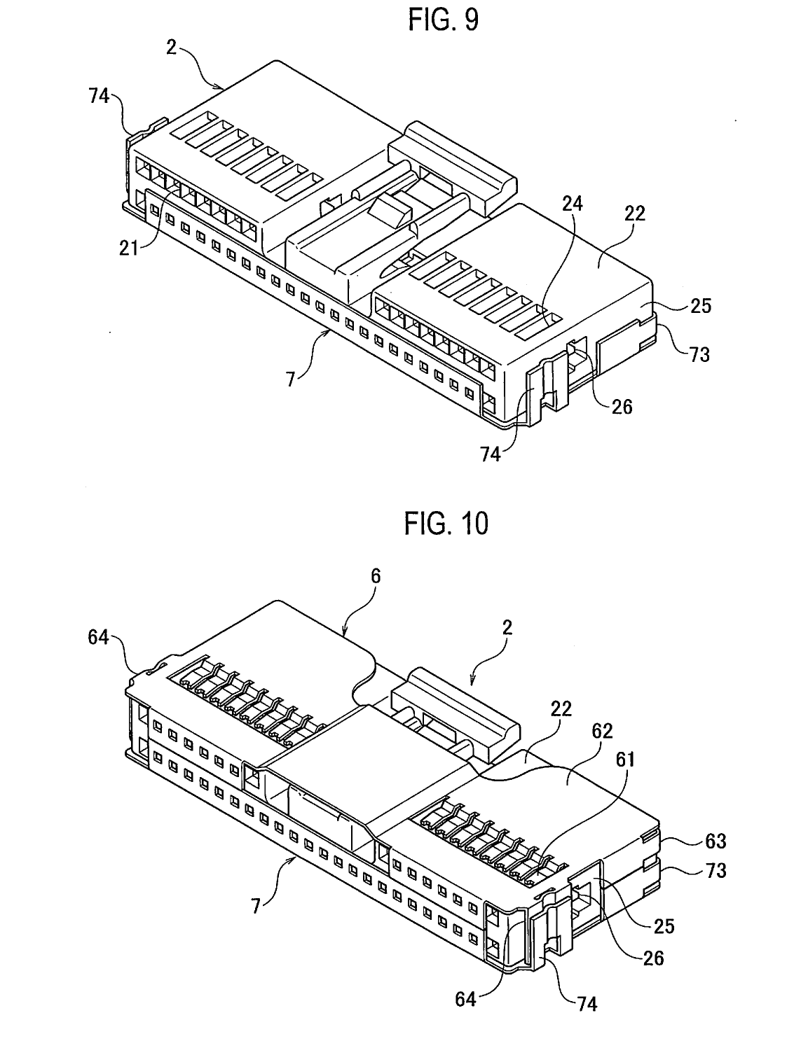

First, in a jig setting process, as illustrated in FIG. 9, the lower jig portion 7 is attached to the lower portion of the connector housing 2 while being positioned by the lower positioning portions 73, so that the lower flexible locking lances 71 are inserted in the terminal chambers 21 of the lower row through the lower lance entry holes 24 of the connector housing 2.

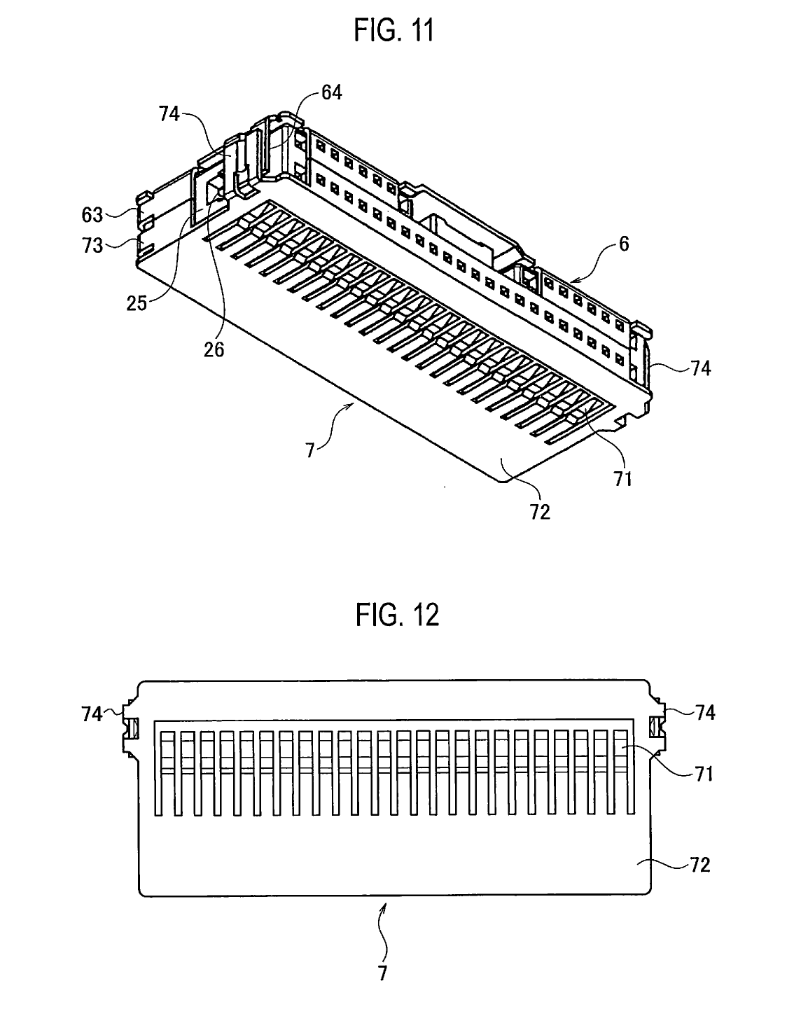

Then, as illustrated in FIG. 10, the upper jig portion 6 is attached to the upper portion of the connector housing 2 while being positioned by the upper positioning portions 63, so that the upper flexible locking lances 61 are inserted in the terminal chambers 21 of the upper row through the upper lance entry holes 24 of the connector housing 2. The upper locking portions 64 and the lower locking portions 74 overlap each other so as to keep the jig 8 attached to the connector housing 2 (refer to FIGS. 11 to 16).

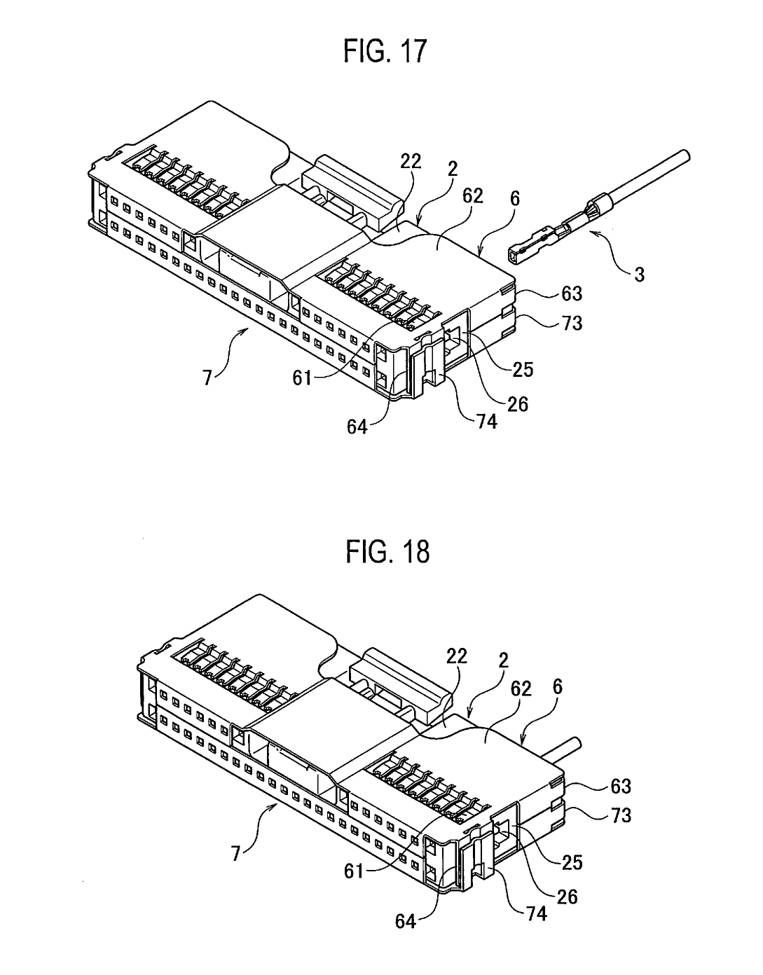

Then, in a terminal housing process, as illustrated in FIGS. 17 and 18, the terminal 3 is inserted into the terminal chamber 21 of the lower row of the connector housing 2 from the rear side. The locking groove 33 of the housed terminal 3 is then locked with the lower flexible locking lance 71 so that the housed terminal 3 is prevented from moving in the direction opposite to the insertion direction of the terminal 3. Similarly, the terminal 3 is inserted into the terminal chamber 21 of the upper row of the connector housing 2 from the rear side. The locking groove 33 of the housed terminal 3 is thus locked with the upper flexible locking lance 61 so that the housed terminal 3 is prevented from moving in the direction opposite to the insertion direction of the terminal 3.

As described above, when the terminals 3 required for a composition circuit of a wire harness are inserted into the terminal chambers 21, a preliminary locking is carried out by the upper flexible locking lances 61 and the lower flexible locking lances 71. The confirmation as to whether the respective terminals 3 reach a predetermined position after the insertion, is performed in a manner such that the terminals 3 in the preliminary locked state are pulled in the direction opposite to the insertion direction.

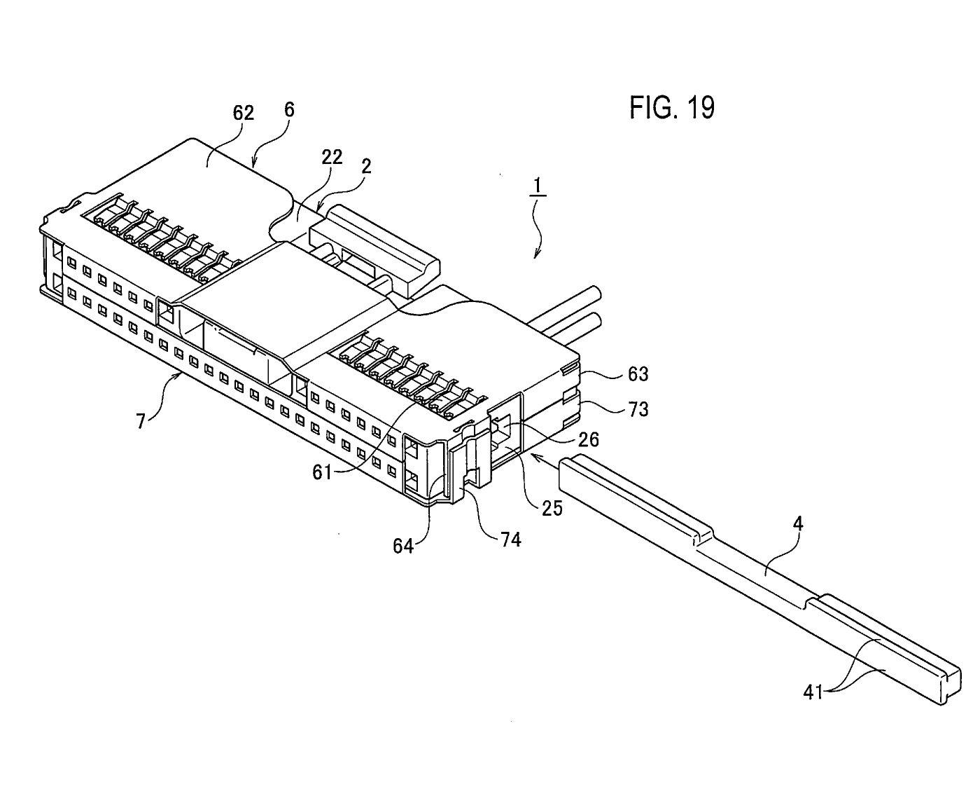

Then, in a retainer insertion process, as illustrated in FIG. 19, the retainer 4 is inserted into the retainer insertion hole 26 of the connector housing 2. The recess portion 32 of each of the terminals 3 housed in the respective terminal chambers 21, is thus locked with the projections 41 of the retainer 4. As a result, all of the terminals 3 are prevented from moving in the direction opposite to the insertion direction of the terminals 3 (secondary locking). When one of the terminals 3 is not sufficiently inserted to reach the predetermined position in the terminal chamber 21, the retainer 4 cannot be inserted in the connector housing 2. Therefore, the confirmation as to whether the terminals 3 are still on the way to the predetermined position can be made by the insertion of the retainer 4.

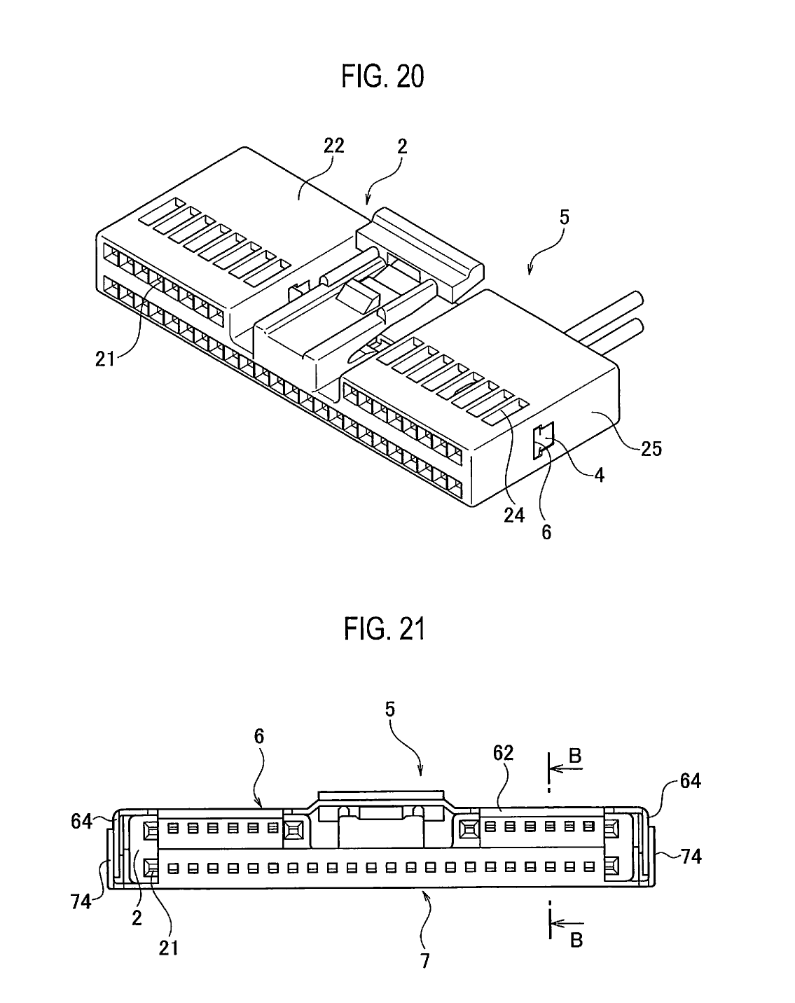

Then, in a jig removing process, the jig 8 is removed from the connector housing 2 as illustrated in FIG. 20. Thus, the upper flexible locking lances 61 and the lower flexible locking lances 71 are separated from the terminals 3 in the connector housing 2. As a result, the terminals 3 are released from the upper flexible locking lances 61 and the lower flexible locking lances 71 that have prevented the terminals 3 from moving in the direction opposite to the insertion direction of the terminals 3. However, the terminals 3 are still prevented from moving in the direction opposite to the insertion direction due to the retainer 4 since the retainer 4 is still inserted in the retainer insertion hole 26 of the connector housing 2.

Thereafter, a circuit error check of the connector 5 including the connector housing 2, the terminals 3, and the retainer 4 is carried out, thereby completing the connector 5 as a composition member for the wire harness.

Accordingly, all of the terminals 3 required for the constitution circuit of the wire harness are attached to the connector 5 thus obtained. The attached state of the terminals 3 to the connector 5 is maintained by the retainer 4.

As described above, in the state where the jig 8 including the upper flexible locking lances 61 and the lower flexible locking lances 71 is attached to the connector housing 2, the terminals 3 and the retainer 4 are attached to the connector housing 2 in a manner such that the terminals 3 are locked with the retainer 4. Thereafter, the jig 8 is removed from the connector housing 2. Due to such a configuration, it is possible to lock the terminals 3 during the process and after the process of attaching the terminals 3 to the connector housing 2 without providing the flexible locking lances in the connector housing 2. Therefore, it is possible to eliminate the flexible locking lances themselves and motion spaces for the flexible locking lances from the connector housing 2. Accordingly, it is possible to reduce the size and weight of the connector 5 including the connector housing 2, the terminals 3, and the retainer 4.

In the connector 5 according to the embodiment, the flexible locking lances themselves and motion spaces for the flexible locking lances can be eliminated from the connector housing 2. Accordingly, it is possible to achieve cost-cutting by reducing die machining cost of the flexible locking lances.

In the connector 5 according to the embodiment, the attached state of the terminals 3 to the connector housing 2 is released in a manner such that the retainer 4 is removed from the retainer insertion hole 26 of the connector housing 2. Therefore, it is possible to easily disassemble the connector 5.

The jig 8 includes the plurality of upper flexible locking lances 61 and the plurality of flexible locking lances 71. Therefore, the jig 8 can be applied to the connector housing 2 including the plurality of terminal chambers 21.

The jig 8 includes the upper jig portion 6 and the lower jig portion 7. Therefore, the jig 8 can be applied to the connector housing 2 including the terminal chambers 21 arranged in the upper and lower rows.

What is claimed is:

1. A connector assembling structure, comprising:
a connector comprising
a connector housing provided with a terminal chamber, a lance entry hole opening into the terminal chamber, and a retainer insertion hole opening into the terminal chamber,
a terminal inserted and housed in the terminal chamber, and
a retainer inserted in the retainer insertion hole to lock the terminal housed in the terminal chamber and thereby to prevent the terminal from moving in a direction opposite to an insertion direction of the terminal; and
a jig detachably provided on the connector housing, and including a flexible locking lance which enters the terminal chamber via the lance entry hole in a state in which the jig is attached to the connector housing, wherein
after attaching the jig to the connector housing, the terminal is housed in the connector housing by inserting the terminal to the terminal chamber, then the retainer is inserted in the retainer insertion hole, and
the jig is removed from the connector housing in a state where the terminal is locked to both of the flexible locking lance and the retainer.

2. The structure according to claim 1, comprising two or more sets of the terminal chamber, the lance entry hole, the terminal, and the flexible locking lance.

3. The structure according to claim 1, wherein the jig is composed of a pair of upper and lower portions.

4. A connector assembling method comprising:
attaching a jig to a connector housing;
inserting a flexible locking lance of the jig into a terminal chamber of the connector housing via a lance entry hole of the connector housing;
inserting and housing a terminal in the terminal chamber;
locking the terminal housed in the terminal chamber with the flexible locking lance to prevent the terminal from moving in a direction opposite to an insertion direction of the terminal;
inserting a retainer into a retainer insertion hole of the connector housing; locking the terminal with the retainer to prevent the terminal from moving in the direction opposite to the insertion direction of the terminal;
removing the jig from the connector housing in a state where the terminal is locked to both of the flexible locking lance and the retainer;
releasing the terminal from locking with the flexible locking lance; and
retaining to lock the terminal with the retainer.
